(19) United States
(12) Patent Application Publication
(10) Pub. No.: US 2018/0370313 A1
(43) Pub. Date: Dec. 27, 2018

(54) TRANSVERSE LEAF SPRING ARRANGEMENT OF A CHASSIS AXLE OF A MOTOR VEHICLE

(71) Applicant: Dr. Ing. h.c. F. Porsche Aktiengesellschaft, Stuttgart (DE)

(72) Inventor: Andreas Higle, Stuttgart (DE)

(73) Assignee: Dr. Ing. h.c. F. Porsche Aktiengesellschaft, Stuffgart (DE)

(21) Appl. No.: 15/975,865

(22) Filed: May 10, 2018

(30) Foreign Application Priority Data
Jun. 23, 2017 (DE) 102017113939.7

(51) Int. Cl. B60G 11/08; B60G 11/10

(52) U.S. Cl. CPC B60G 11/08; B60G 2202/114; B60G 2204/121; B60G 11/10

(57) ABSTRACT

A transverse leaf spring arrangement of a chassis axle of a motor vehicle having a transverse leaf spring which is mounted via two outer bearing members on, in each case, one wheel support and via two central bearing members on a vehicle body. The central bearing members, in each case, have an actuator device, which actuator devices act on a bearing shell of the respective central bearing member in such a way that a bearing point can be adjusted in the direction of the vertical axis and/or transverse axis of the motor vehicle. The actuator device is configured in such a way that, in the case of a stationary bearing shell, an adjustment of the bearing point is possible in the direction of the vertical axis and/or transverse axis of the motor vehicle.

### CROSS-REFERENCE TO RELATED APPLICATION

This application claims priority to German Patent Application No. DE 10 2017 113 939.7 filed Jun. 23, 2017, which is incorporated by reference herein in its entirety.

### FIELD OF THE INVENTION

The present invention relates to a transverse leaf spring arrangement of a chassis axle of a motor vehicle having a transverse leaf spring which is mounted via two outer bearing members on in each case one wheel support and via two central bearing members on a vehicle body, the central bearing members in each case having an actuator device, which actuator devices act on a bearing shell of the respective central bearing member in such a way that a bearing point can be adjusted in the direction of the vertical axis and/or transverse axis of the motor vehicle.

### BACKGROUND OF THE INVENTION

A transverse leaf spring arrangement is part of a chassis. The wheels, the wheel suspension system, the spring system, the shock absorbers and the steering system belong to a chassis. The transverse leaf spring arrangement has substantially a transverse leaf spring which is mounted via two outer bearing members in each case to a wheel support and via two central bearing members on a vehicle body. Via the embodiment of the transverse leaf spring or its influence, it is possible to achieve a spring rate, stabilization properties and a level regulation of the vehicle. Here, the spring rate has a crucial influence on the deflection of the motor vehicle, the stabilization properties have a crucial influence on the body roll behavior of the vehicle, and the level regulation has a crucial influence on the ride height.

DE 10 2010 058 388 A1, which is incorporated by reference herein, discloses adjusting the central bearing members in the direction of the vertical and transverse axes by means of actuators. This makes it possible to adjust the spring rate and/or the ride height.

An arrangement of this type has the disadvantage, however, that the complete bearing shell has to be adjusted. As a result, first of all increased construction-induced complexity of the entire bearing apparatus with the associated costs is necessary. In addition, the bearing shell is subject to wear which can reduce the service life.

### SUMMARY OF THE INVENTION

Disclosed herein is a transverse leaf spring arrangement of a chassis axle, which transverse leaf spring arrangement avoids the abovementioned disadvantages in a simple and inexpensive way.

The actuator device is configured in such a way that, in the case of a stationary bearing shell, an adjustment of the bearing point is possible in the direction of the vertical axis and/or transverse axis of the motor vehicle. As a result, it is possible to bring about an adaptation of chassis characteristics in a particularly simple way.

In one advantageous embodiment, the actuator device is configured as a linear/diagonal actuator which is arranged such that it can be moved on the bearing shell in the transverse direction. Depending on how a setting angle α is adjusted, the bearing point can be shifted in the bearing shells.

In a first alternative embodiment, the actuator device is configured as an eccentric actuator which is arranged such that it can be moved on the bearing shell in the transverse direction. Here, the bearing point is adjusted by way of a corresponding eccentric rotation. In a further alternative embodiment, the actuator device is configured by way of at least two chambers which are arranged in the bearing shell and define the desired bearing point by way of a hydraulic or pneumatic actuation.

Moreover, it can be provided in an advantageous way that the actuator device has a torque generation apparatus, the torque direction of which runs parallel to a longitudinal axis of the motor vehicle. Means can likewise be provided which adjust the outer bearing members in the direction of the vertical axis and/or transverse axis.

### BRIEF DESCRIPTION OF THE DRAWING FIGURES

The invention will be described in greater detail using a drawing, in which:

FIG. 1 shows a front view of a motor vehicle having a diagrammatically shown transverse leaf spring arrangement, and

FIGS. 2a, 2b and 2c show a diagrammatic illustration of the transverse leaf spring arrangement according to aspects of the invention having different actuator devices.

### DETAILED DESCRIPTION OF THE INVENTION

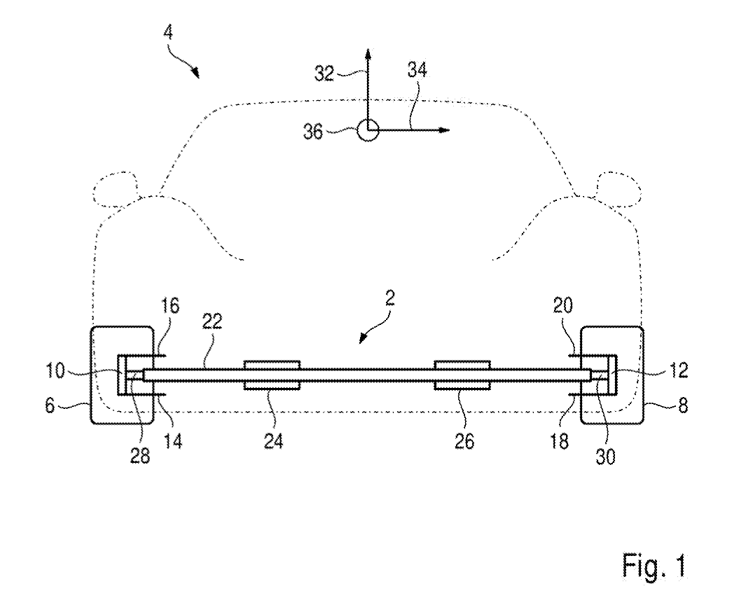

FIG. 1 shows a diagrammatic front view of a transverse leaf spring arrangement 2 according to aspects of the invention which is a constituent part of a front axle arrangement (not shown in further detail) of a motor vehicle 4. The designations 6, 8 denote two front wheels which are arranged on wheel supports 10, 12 in each case in a known way. The wheel supports 10, 12 are connected, inter alia, via diagrammatically shown links 14, 16, 18, 20 to a vehicle body (not shown in detail) of the motor vehicle 4. A transverse leaf spring 22 of the transverse leaf spring arrangement 2 is mounted via central bearing members 24, 26 on the vehicle body of the motor vehicle 4 and via outer bearing members 28, 30 on the wheel supports 10, 12. The motor vehicle 4 has a vertical axis 32, a transverse axis 34 and a longitudinal axis 36 in a known way.

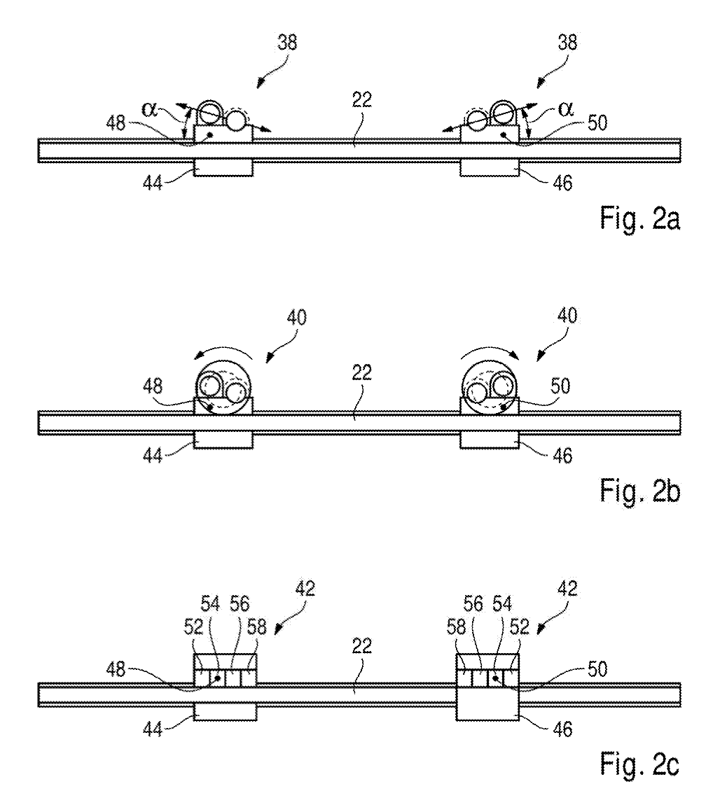

FIGS. 2a, 2b and 2c then show transverse leaf spring arrangements 2 according to aspects of the invention having different actuator devices 38, 40, 42. Here, FIGS. 2a and 2b show an alternative position of the respective actuator device 38, 40 using dashed lines. Here, the transverse leaf spring arrangements 2 are fundamentally shown diagrammatically, merely the central bearing members 24, 26 being denoted and described. Here, the central bearing members 24, 26 in each case have a bearing shell 44, 46, in which the transverse leaf spring 2 is received, and an introduction of force taking place at a respective bearing point 48, 50.

Here, FIG. 2a shows a transverse leaf spring arrangement 2 having an actuator device 38 which is configured in each case as a linear/diagonal actuator which is arranged such that it can be moved on the bearing shell 44, 46 in the transverse direction. As a result, it is possible in a simple way to move the bearing point 48, 50 in the respective central bearing members 24, 26, without moving an associated bearing shell 44, 46. The linear/diagonal actuator 38 which is shown here can have, for example, a spindle drive which moves the respective bearing point 48, 50 at a preset or adjustable angle α. A change of the spring rates and ride height can then take place in a manner which is dependent on the angle α.

FIG. 2b shows a second embodiment of an actuator device with the designation 40, which actuator device is configured in this case as an eccentric actuator which is arranged such that it can be moved on the bearing shell in the direction of the transverse axis 34. It is also possible in a simple way hereby to move the bearing point 48, 50 in the respective central bearing members 24, 26, without moving an associated bearing shell 44, 46. A change of the spring rates and ride height can then take place in a manner which is dependent on the configuration of the eccentric.

Finally, FIG. 2c shows a third embodiment of an actuator device with the designation 42, in each case four chambers 52, 54, 56, 58 being configured in the bearing shell 44, 46 of the respective bearing shell 44, 46 in the present exemplary embodiment, which chambers 52, 54, 56, 58 define a desired bearing point 48, 50 by way of a hydraulic or pneumatic actuation. It is possible in a simple way by way of a suitable actuation of chambers 52, 54, 56, 58 to move the respective bearing point 48, 50 both in the direction of the vertical axis 32 and in the direction of the transverse axis 34.

It should be clear that many input variables can be used in order to set bearing points 48, 50 of the respective central bearing members 24, 26 in the respective operating situations.

Moreover, the actuator devices 38, 40, 42 can have a torque generation apparatus, the torque direction of which runs parallel to a longitudinal axis of the motor vehicle. The outer bearing members can also be adjusted in the direction of the vertical axis and/or transverse axis 32, 34 of the motor vehicle 4.

What is claimed is:

1. A transverse leaf spring arrangement of a chassis axle of a motor vehicle, said transverse leaf spring arrangement comprising:
a transverse leaf spring (22) which is mounted via two outer bearing members (28, 30) on, in each case, one wheel support (10, 12), the transverse leaf spring also mounted via two central bearing members (24, 26) on a vehicle body,
each central bearing member (24, 26) having an actuator device (38; 40; 42),
each actuator device each being configured to act on a bearing shell (44, 46) of the respective central bearing member (24, 26) to adjust a bearing point (48, 50) in a direction of a vertical axis or transverse axis (32, 34) of the motor vehicle (4),
wherein each actuator device (38; 40; 42) is configured in such a way that, in a case of the bearing shell (44, 46) being maintained stationary, each actuator device is configured to adjust the bearing point (48, 50) in the direction of the vertical axis or transverse axis (32, 34) of the motor vehicle (4).

2. The transverse leaf spring arrangement as claimed in claim 1, wherein the actuator device (38) is configured as a linear/diagonal actuator which is arranged such that the actuator device (38) is configured to be moved on the bearing shell (44, 46) in the direction of the vertical axis or transverse axis (32, 34).

3. The transverse leaf spring arrangement as claimed in claim 1, wherein the actuator device (40) is configured as an eccentric actuator which is arranged such that the actuator device (40) is configured to be moved on the bearing shell (44, 46) in the direction of the vertical axis or transverse axis (32, 34).

4. The transverse leaf spring arrangement as claimed in claim 1, wherein the actuator device (42) is configured by way of at least two chambers (52, 54, 56, 58) which are arranged in the bearing shell (44, 46) and define the bearing point (48, 50) by way of a hydraulic or pneumatic actuation.

5. The transverse leaf spring arrangement as claimed in claim 1, wherein the actuator device has a torque generation apparatus, a torque direction of which runs parallel to a longitudinal axis of the motor vehicle.

6. The transverse leaf spring arrangement as claimed in claim 1, wherein means are provided which adjust the outer bearing members in the direction of the vertical axis or transverse axis of the motor vehicle.
